(19) United States
(12) Patent Application Publication
(10) Pub. No.: US 2021/0302753 A1
(43) Pub. Date: Sep. 30, 2021

(54) CONTROL APPARATUS, CONTROL METHOD, AND PROGRAM

(71) Applicant: SONY CORPORATION, TOKYO (JP)

(72) Inventor: RYUICHI SUZUKI, TOKYO (JP)

(21) Appl. No.: 17/250,563

(22) PCT Filed: Jul. 26, 2019
(86) PCT No.: PCT/JP2019/029363

§ 371 Date: Feb. 3, 2021

(30) Foreign Application Priority Data
Aug. 10, 2018 (JP) 2018-151532

(51) Int. Cl. G02B 27/14; G02B 27/09; G03B 21/20; G03B 21/14

(52) U.S. Cl. CPC G02B 27/14; G03B 21/145; G03B 21/2066; G02B 27/0977

(57) ABSTRACT

The present disclosure relates to a control apparatus, a control method, and a program, which make it possible to project an image in a wider range appropriately. On the basis of posture information indicative of a posture of a mirror capable of reflecting at least part of projection light outputted from a projection unit for projecting an image content, an image process for compensation to rotate or reverse the image content is performed to the image content. After that, the posture of the mirror in pitch and roll directions is controlled for outputting the image content thus subjected to the image process from the projection unit. The present technology is applicable to a projector with a mirror reflection mechanism, for example.

### TECHNICAL FIELD

The present disclosure relates to a control apparatus, a control method, and a program, and more specifically to a control apparatus, a control method, and a program, which are improved to be capable of projecting an image appropriately in a wider range.

### BACKGROUND ART

Conventionally, some schemes for projecting an image on a desired projection surface in space have been proposed. For example, one of such schemes is a scheme for moving a projector itself. This scheme requires the projector to have a higher illumination if an image is to be projected in a bright environment or in a wide area, as a result of which the projector becomes larger in size inevitably. As a result of this, the scheme for moving the projector itself needs a large equipment size.

Therefore, in order to avoid inevitably giving a large size to the projector, a scheme for moving not the projector itself but a mirror thereof to reflect an image on a desired projection surface in a space has been proposed. However, due to restrictions from mechanism of a mirror unit itself and restrictions from mirror itself, a range of projection of the image in the scheme for moving the mirror is narrower than in the scheme for moving the projector itself.

For example, Patent Document 1 discloses a projection apparatus capable of projecting a plurality of images separately at desired display positions by projecting the plurality of images from a single projection means and using light-directing means such as a mirror.

### CITATION LIST

### Patent Document

Patent Document 1: Japanese Patent Application Laid-Open No. 2001-305683

### SUMMARY OF THE INVENTION

### Problems to be Solved by the Invention

By the way, in a case where an image is projected in a wide area on a side surface, a ceiling surface, a floor surface, or the like in a room by using a scheme as described above, for example, sometimes the image would be recognized as not been properly projected, and a solution for this drawback has been required.

The present disclosure has been achieved in view of these circumstances, and makes it possible to project an image appropriately in a wider range.

### Solutions to Problems

A control apparatus according to an aspect of the present disclosure includes a compensation process unit configured to perform a compensation process to an image content projected by a projection unit, the compensation process unit performing the compensation process on the basis of posture information indicative of a posture of a mirror configured to be capable of reflecting at least part of projection light outputted from the projection unit, and a control unit configured to control output of the image content from the projection unit, the image content having been subjected to the compensation process by the compensation process unit.

A control method or a program according to an aspect of the present disclosure includes performing a compensation process to the image content on the basis of posture information indicative of a posture of a mirror configured to be capable of reflecting at least part of projection light outputted from a projection unit configured to project the image content, and controlling output of the image content from the projection unit, the image content having been subjected to the compensation process.

According to an aspect of the present disclosure, a compensation process to the image content is performed on the basis of posture information indicative of a posture of a mirror configured to be capable of reflecting at least part of projection light outputted from a projection unit configured to project the image content, and output of the image content from the projection unit is controlled, the image content having been subjected to the compensation process.

### Effects of the Invention

According to one aspect of the present disclosure, it becomes possible to project an image appropriately in a wider range.

Note that the effects described in the specification are not limited. That is, the present disclosure can exhibit any of the effects that are described in the present disclosure.

### BRIEF DESCRIPTION OF DRAWINGS

FIG. 1 is a view illustrating an exemplary configuration of an embodiment of a projection system, to which the present technology is applied.

FIG. 2 is a view illustrating a configuration of an outer appearance of a mirror reflection-type projector.

FIG. 3 is a view for explaining an operating state of a mirror in the mirror reflection-type projector.

FIG. 4 is a view for explaining a stored state of the mirror in the mirror reflection-type projector.

FIG. 5 is a view illustrating exemplary implementations of the mirror reflection-type projector.

FIG. 6 is a view for explaining how to decide a projection direction of projection of a content.

FIG. 7 is a view for explaining how to set a mirror unuse area.

FIG. 8 is a view for explaining an image process for image combination for an image to be projected across a mirror unuse boundary.

FIG. 9 is a block diagram illustrating an exemplary functional configuration of the projection system.

FIG. 10 is a flowchart for explaining a content output control process.

FIG. 11 is a view for defining a cross-sectional direction of a space with respect to the mirror reflection-type projector.

FIG. 12 is a view schematically illustrating pitch rotation of the mirror.

FIG. 13 is a view illustrating relationship between a mirror length and a mirror tilt angle of a mirror.

FIG. 14 is a view illustrating one example of an image projected with no consideration for a direction of a content.

FIG. 15 is a view for explaining movement of the mirror and compensation process in case of projecting an image with no consideration for the direction of the content.

FIG. 16 is a view illustrating an example of an image projected with consideration for the direction of the content.

FIG. 17 is a view for explaining movement of the mirror and compensation process in case of projecting an image with consideration for the direction of the content.

FIG. 18 is a view illustrating a configuration of an outer appearance of a driven-type projector.

FIG. 19 is a view illustrating one example of an image projected by the driven-type projector.

FIG. 20 is a view for explaining movement of a moving mechanism and compensation process in case of projecting an image by the driven-type projector.

FIG. 21 is a block diagram illustrating an exemplary configuration of one example of a computer, to which the present technology is applied.

### MODE FOR CARRYING OUT THE INVENTION

In the following, more specific embodiments to which the present technology is applied will be described in detail, referring to drawings.

### Exemplary Configuration of Projection System

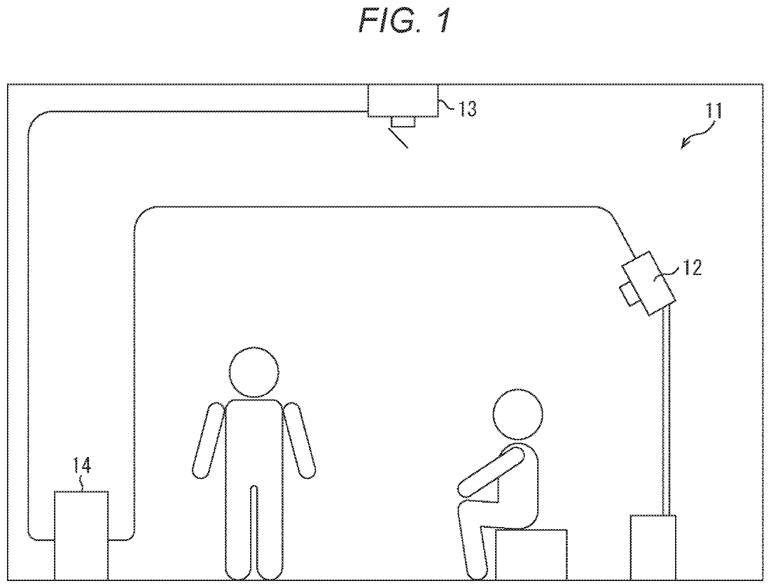

FIG. 1 is a view illustrating an exemplary configuration of an embodiment of a projection system, to which the present technology is applied.

As illustrated in FIG. 1, a projection system 11 includes a sensor module 12, a mirror reflection-type projector 13, and a control process apparatus 14, which are connected with each other. For example, the projection system 11 is configured for use in a room in which a plurality of users is present, and is configured to project an image on a desired projection surface such as a side surface, a ceiling surface, or a floor surface.

The sensor module 12 is configured to obtain user information regarding the users viewing a content by using the projection system 11, environment information regarding environment in which the projection system 11 is used, and pointing information regarding pointing carried out by a pointing device. For example, the sensor module 12 is configured to obtain, as the user information, detection results of positions, postures, face directions, fields of views, lines of sights, hand fingers, and/or the like of one or a plurality of the users. Moreover, the sensor module 12 is configured to obtain, as the environment information, detection results such as a shape of the projection surface on which the image is or will be projected, a roughness of the projection surface, a color of the projection surface, an obstacle or a blocking object in projecting the image, and brightness in the environment in which the image is projected.

Moreover, the sensor module 12 is configured to obtain, as the pointing information, a pointing position in a case where a user uses a pointing device configured to point a position in a space by using light, where the sensor module 12 is configured to detect the pointing position by detecting the light with a camera or the like. The pointing device may be, for example, a pointing device using visible light such as a laser pointer, a pointing device using invisible light such as infrared light for use in a remote controller for controlling a home appliance, or the like. Moreover, the pointing device may be a device in which a scheme for detecting infrared light radiated from a light source at a fixed position and reflected from a retroreflecting member is adopted, a device in which a scheme for estimating a direction by using a gyroscope or an acceleration sensor is adopted, or the like.

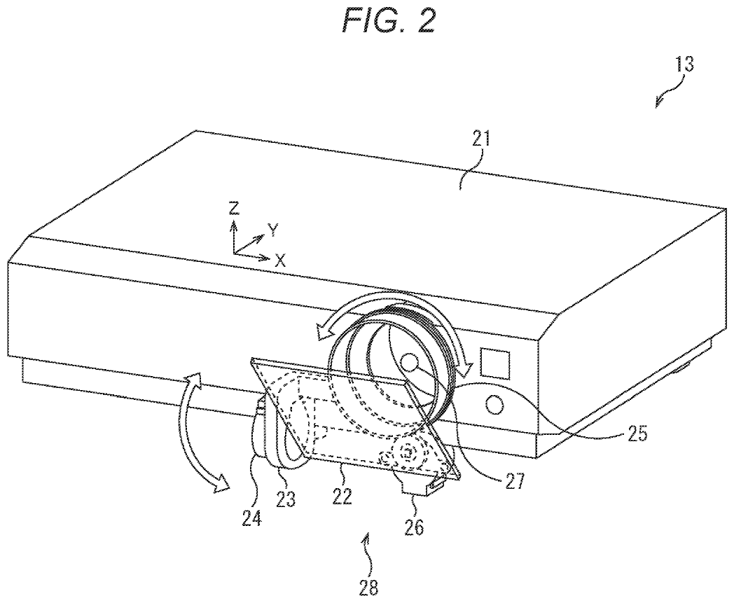

The mirror reflection-type projector 13 is an output apparatus configured to output a content such as a moving image or a still image. For example, the mirror reflection-type projector 13 is capable of moving a mirror 22 as illustrated in FIG. 2, so as to project an image on a desired projection surface according to control by the control process apparatus 14.

The control process apparatus 14 is configured to perform analysis of various information obtained by the sensor module 12 and analysis of a content to be outputted from the mirror reflection-type projector 13, and a content output control process for controlling the output of the content performed by the mirror reflection-type projector 13.

For example, the control process apparatus 14 is configured to calculate out three-dimensional positional relationship and the like on the basis of the information obtained by the sensor module 12, the three-dimensional positional relationship being a relationship between the mirror reflection-type projector 13 and the projection surface. After that, on the basis of a result of the calculation, the control process apparatus 14 analyzes how the image to be projected on the projection surface will be visually recognized by the user, or the like recognition, and processes an image process by an image process for improving the image to be more appropriately viewable.

Moreover, the control process apparatus 14 is configured to analyze an attribute of the content, and utilize the attribute in analyzing the positional relationship between the user and the projection surface or the positional relationship between the projection surface and the mirror reflection-type projector 13, for example, when a trigger for presenting the content to the user in a certain way is triggered, so that the content will be presented with consideration for a format of the content (for example, text, moving image, or the like), a target to present the content, emergency, and the like.

Moreover, the control process apparatus 14 is configured such that, in case the projection system 11 includes a plurality of output apparatuses, the control process apparatus 14 is not only capable of determining a most appropriate output apparatus for presenting the content to user from among the plurality of output apparatuses, but also capable of optimizing a parameter of the output apparatus as well. For example, in case of the mirror reflection-type projector 13, the control process apparatus 14 determines parameters that are set for a zoom mechanism, a focus mechanism, or the like for adjusting brightness or a size of the image to be projected from the mirror reflection-type projector 13.

The projection system 11 is configured as above, and is capable of appropriately projecting the image in a wider range with the configuration that the control process apparatus 14 controls the content to be outputted from the mirror reflection-type projector 13.

### Exemplary Configurations and Exemplary Implementations of the Mirror Reflection-Type Projector

Referring to FIGS. 2 to 5, exemplary configurations and exemplary implementations of the mirror reflection-type projector 13 will be explained herein.

As illustrated in FIG. 2, the mirror reflection-type projector 13 is configured such that the mirror 22 is mounted operably on a projection unit configured to project an image from a projector main unit 21. The mirror 22 is fixed to a pitch arm 23, so that the mirror 22 is movable in a pitch direction with respect to the light axis of the projection unit by rotational movement of the pitch arm 23 driven by a pitch motor 24. Furthermore, the pitch arm 23 and the pitch motor 24 are fixed to a roll arm 25, so that the mirror 22 is movable in a roll direction with respect to the light axis of the projection unit by rotational movement of the pitch arm 23 and the pitch motor 24 driven by a roll motor 26.

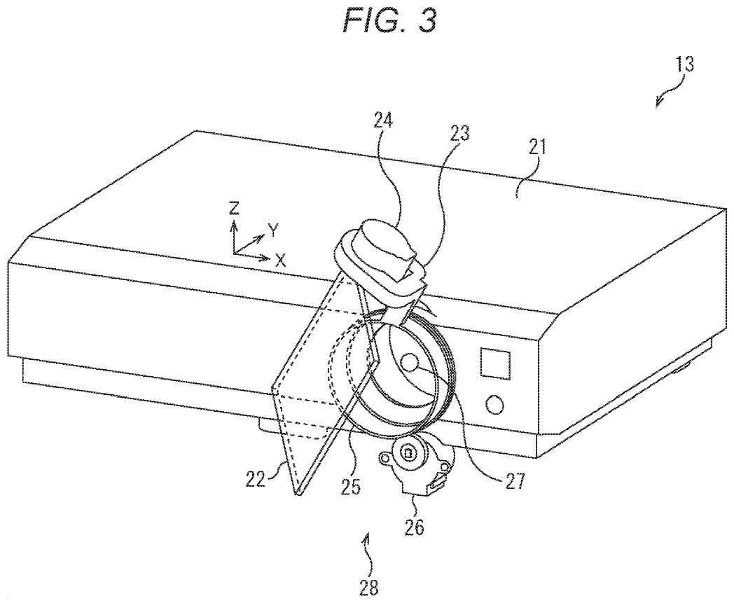

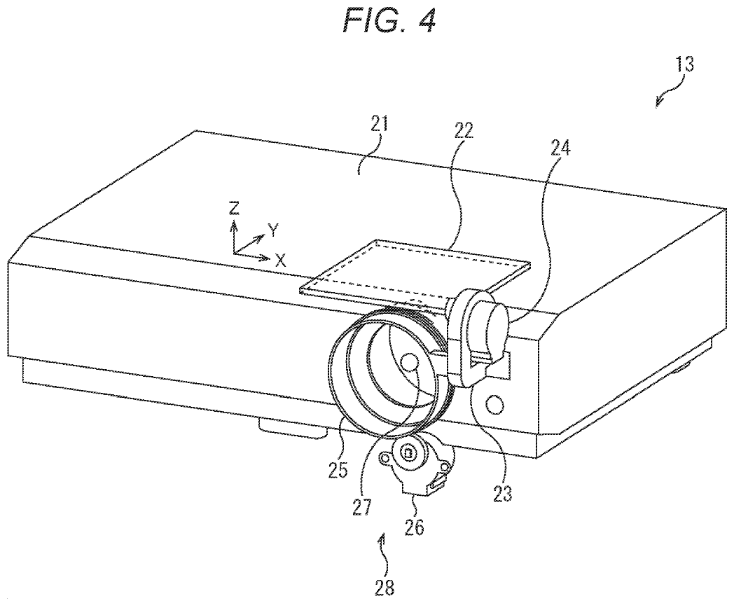

Moreover, the roll arm 25 is configured such that the roll arm 25 will not block a light axis for the projection of the image from a light source 27 provided in the projection unit of the projector main unit 21, and the roll arm 25 is rotatable about the light axis as a rotation axis. For example, FIG. 3 illustrates a state where the mirror 22 is rotated in the roll direction from a state illustrated in FIG. 4, as a result of the driving of the roll motor 26.

Moreover, the pitch arm 23 is configured such that a rotation axis of the pitch arm 23 does not cross with the light axis for the projection of the image from the light source 27. With this configuration, it becomes possible for the mirror reflection-type projector 13 can take a stored state in which the mirror 22 is completely folded down as illustrated in FIG. 4. That is, the mirror reflection-type projector 13 with the mirror 22 in the stored state can be used like a normal projector not configured to reflect an image with the mirror 22.

The mirror reflection-type projector 13 is configured as described above, so that the mirror 22 can be rotated to a desired angle and a desired direction by the pitch arm 23 and the roll arm 25 independently driven by the pitch motor 24 and the roll motor 26. Therefore, the mirror reflection-type projector 13 is capable of projecting the image in a desired direction and a desired orientation by using the reflection by the mirror 22. Note that such a mechanism for projecting an image by using the reflection of the mirror 22 will be referred to as a mirror reflection mechanism 28 below for the sake of easy explanation.

It should be noted that zooming, focusing, lens shifting, and the like function provided as functions of the projector main unit 21 may be used for adjusting in projecting a content by the mirror reflection-type projector 13.

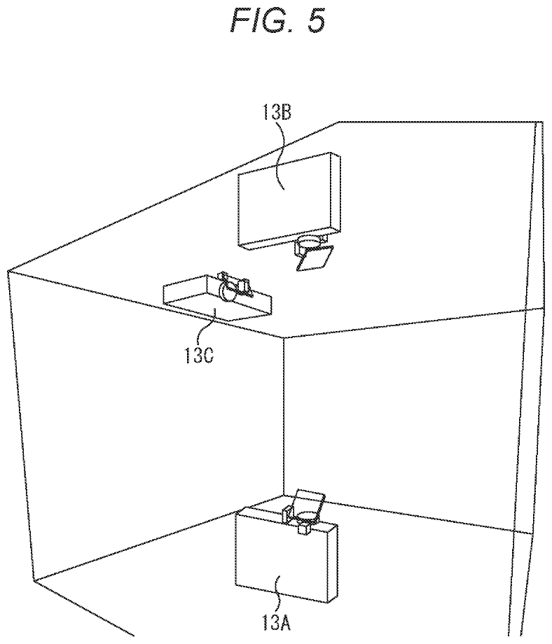

Further, FIG. 5 illustrates exemplary implementations of the mirror reflection-type projector 13.

For example, a mirror reflection-type projector 13A is an exemplary implementation in which the mirror-reflection-type projector 13A is embedded in a floor surface in such a way that a mirror reflection mechanism 28 is exposed from the floor surface with a projection unit of the projector main unit 21 facing toward a ceiling surface. Moreover, a mirror reflection-type projector 13B is an exemplary implementation in which the mirror-reflection-type projector 13B is embedded in a ceiling surface in such a way that a mirror reflection mechanism 28 is exposed from the ceiling surface with a projection unit of the projector main unit 21 facing toward a floor surface.

Moreover, a mirror reflection-type projector 13C is an exemplary implementation in which the mirror reflection-type projector 13C is hung from a ceiling surface in such a way that a light axis is substantially in a horizontal direction (that is, so-called general hanging type). Note that a general projector may be provided with a mirror reflection mechanism 28, thereby being configured like the mirror reflection-type projector 13C.

In should be noted that, as described above, the mirror reflection-type projector 13 can project the image in a desired direction and in a desired orientation, and the implementation of the mirror reflection-type projector 13 is not limited to the exemplary implementations as illustrated in FIG. 3.

### Output Control of Content

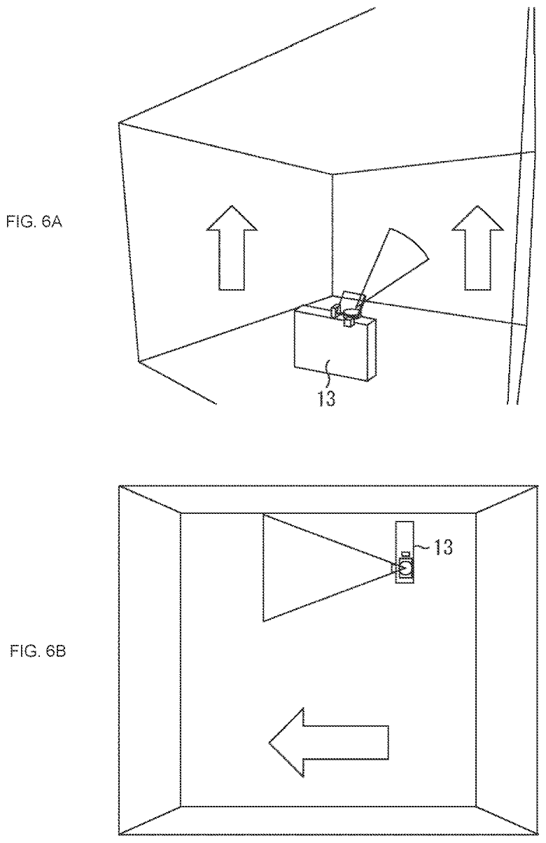

Referring to FIGS. 6 to 8, basic control for outputting a content in the projection system 11 will be explained.

FIG. 6 is a view for explaining how to decide a projection direction of projection of a content.

For example, in a case where a content has a direction with an upside and a downside, it is desirable that the content be projected from the mirror reflection-type projector 13 in such a way that the content is so oriented that the content can be easily viewed by the user using the projection system 11, for example, in such a way that the content will not be upside down from a view point of the user.

As illustrated in A of FIG. 6, in a case where the projection surface is a side surface of a room, the control process apparatus 14 decides the projection orientation in such a way that the content will be upside up toward the ceiling surface. With this configuration, for example, the content to be projected on the side surface of the room will not be upside down from the view point of the user standing or sitting as illustrated in FIG. 1, so that the content will be projected appropriately from the mirror reflection-type projector 13.

As illustrated in B of FIG. 6, in a case where the projection surface is the floor surface or the ceiling surface of the room, the control process apparatus 14 decides the orientation of the content according to a position or a face direction of the user, for example. For example, when the user is lying face upwards on the floor surface, the control process apparatus 14 decides projection orientation of the content according to a posture of the user in such a way that the upside of the content will be a head side of the user, so that the content will be projected appropriately from the mirror reflection-type projector 13.

As described above, the projection system 11 is configured such that the projection orientation for projecting the content is decided according to the projection surface on which the content is to be projected, and usage environment such as the posture of the user who will view the content.

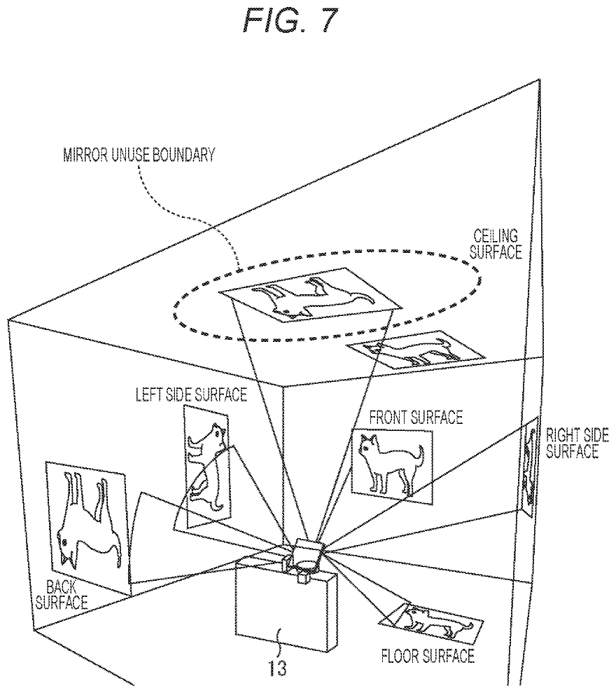

FIG. 7 is a view for explaining setting of a mirror unuse area for projecting a content by the mirror reflection-type projector 13.

For example, the projection system 11 is configured such that the mirror unuse area in which the reflection of the mirror 22 is not utilized in projecting a content by the mirror reflection-type projector 13, and the control according to where to output the content is carried out.

In case where the mirror reflection-type projector 13 is implemented on the floor surface with the projection unit facing toward the ceiling as illustrated in FIG. 7, the mirror unuse area is set on the ceiling surface right in front of the mirror reflection-type projector 13. The mirror unuse area is set within a projection range in which the mirror reflection-type projector 13 can directly project the content from the projection unit of the projector main unit 21 without using the mirror reflection mechanism 28.

For example, the mirror unuse area is set according to specifications (such as angle of view, zoom ratio, focus, and lens shift) of the mirror reflection-type projector 13 and a distance from the mirror reflection-type projector 13 to the projection surface. In the example illustrated in FIG. 7, an inside of a mirror unuse boundary indicated by a broken line is the mirror unuse area, and an outside of mirror unuse boundary is out-of-range of the mirror unuse area.

It should be noted that the mirror unuse area may be set to be narrower by excluding, from the mirror unuse area, part of the projection range to which the content can be projected directly from the projection unit of the projector main unit 21. For example, in a vicinity of the mirror unuse boundary, there is a possibility that the tilt angle of the mirror 22 is close to the perpendicular angle with respect to the mirror reflection-type projector 13, which would possibly result in poor resolution of the image on the projection surface on which the image is projected by the reflection from the mirror 22, thereby causing the vicinity of the mirror unuse boundary to be not suitable for the projection via the mirror 22. Thus, for example, it may be so configured that, based on the resolution (fineness) of the image projected, the user determines whether or not the area is suitable for the projection of the image, and the mirror unuse area is adjusted according to the determination.

Here, the projection of the content by the mirror reflection-type projector 13 would have a case where the content is projected out of the mirror unuse area, a case where the content is projected in the mirror unuse area, and a case where the content is projected across the mirror unuse boundary.

For example, in the case where the content is projected out of the mirror unuse area, the mirror reflection-type projector 13 reflects the content on the mirror 22. Thus, it is necessary that the mirror reflection-type projector 13 perform the image process for compensating the content with consideration for reversing of the content as a result of the reflection of the mirror 22.

That is, as indicated by the content projected on the side surfaces as illustrated in FIG. 7, if the content is projected in such a way that the content is upside up when projected on the front surface, the projections on the right side surface, the left side surface, the back surface, and the like would be such that the content is upside down as a result of the reflection on the mirror 22. Therefore, if the content has a direction with an upside and a downside, as explained referring to FIG. 6, it is necessary that the projection orientation of the content be decided and an image process for rotating or reversing the content be carried out to project the content upside up according to the projection orientation.

As described above, for example, the scheme for projecting with mirror operation is different from the scheme for projecting with the projector operation in terms of how to project the image, and is configured such that a compensation process for absorbing the difference is carried out.

Moreover, in the case where the content is projected in the mirror unuse area, the content would be within the original angle of view of the mirror reflection-type projector 13 and therefore a compensation process within the angle of view (for example, an image process for adjusting a shape and a size of a square image so that the square image will not be distorted into a trapezoid when projected slantly).

For example, on the ceiling surface as illustrated in FIG. 7, the content projected in the mirror unuse area and the content projected out of the mirror unuse area are oriented upside down. Thus, it is necessary to carry out an image process for reversing, in advance, either the content in the mirror unuse area or the content out of the mirror unuse area in consideration of the reversing of the content by the mirror 22. With this configuration, it is possible to orient the content in the mirror unuse area and the content out of the mirror unuse area in the same way.

Furthermore, in the case where the content is projected across the mirror unuse boundary, part of the content is projected upside down due to the mirror 22 while the remaining part of the content is projected as such. Thus, it is necessary that the projection system 11 divide the content into the part projected upside down due to the mirror 22 and the remaining part, and combine the part and the remaining part back into the original content when projected across the mirror unuse boundary. In doing so, the projection system 11 is configured to carry out an image process for rotating or reversing the part projected upside down due to the mirror 22, and do not carry out the image process to the remaining part.

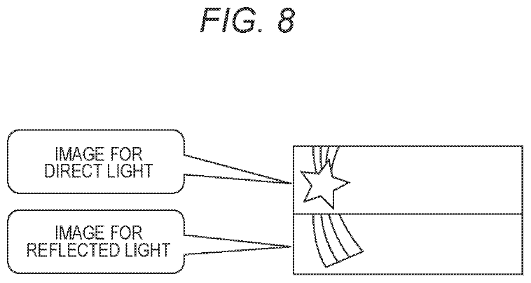

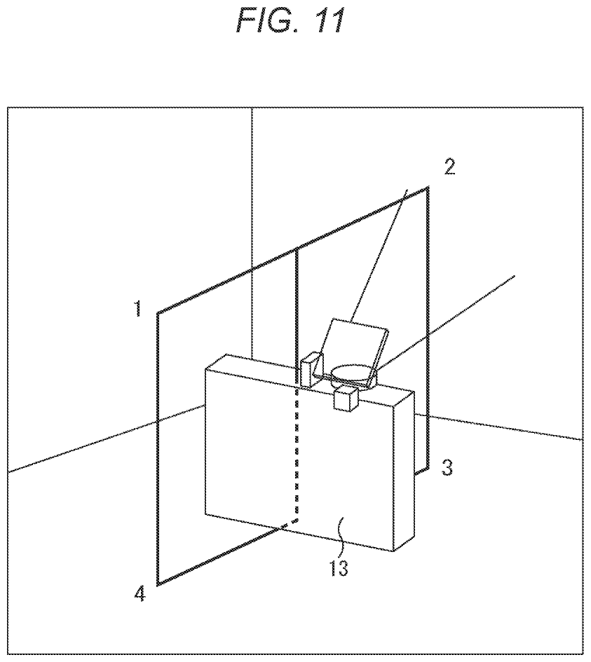

That is, as illustrated in FIG. 8, the image projected by the mirror reflection-type projector 13 is divided into an image assigned to direct light not reflected by the mirror 22 and an image assigned to reflection light reflected by the mirror 22, and these images are combined back into one image. In doing so, an image process is carried out in such a way that the image assigned to direct light not reflected by the mirror 22 and the image assigned to reflection light reflected by the mirror 22 will be combined back into the original image when the image assigned to direct light not reflected by the mirror 22 and the image assigned to reflection light reflected by the mirror 22 are projected across the mirror unuse boundary. Note that the combining of the two images will be described later referring to FIGS. 11 to 13.

### Exemplary Functional Configuration of Projection System

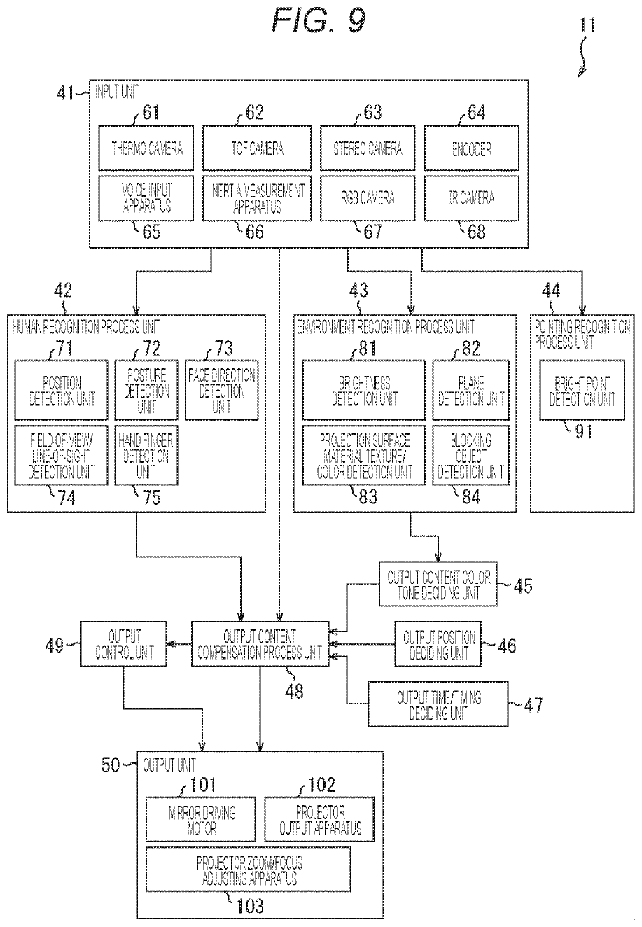

FIG. 9 is a block diagram illustrating an exemplary functional configuration of the projection system 11. Note that, as illustrated in FIG. 1, the projection system 11 includes the sensor module 12, the mirror reflection-type projector 13, and the control process apparatus 14, and functional blocks illustrated in FIG. 9 may be included in any one of the sensor module 12, the mirror reflection-type projector 13, or the control process apparatus 14 as a function thereof.

As illustrated in FIG. 9, the projection system 11 includes an input unit 41, a human recognition process unit 42, an environment recognition process unit 43, a pointing recognition process unit 44, an output content color tone deciding unit 45, an output position deciding unit 46, an output time/timing deciding unit 47, an output content compensation process unit 48, an output control unit 49, and an output unit 50.

The input unit 41 is configured to receive an image, information, or the like obtained via various input apparatuses. For example, the input 41 includes a thermo camera 61 configured to obtain a heat-distribution image, a time-of-flight (TOF) camera 62 configured to obtain a distance image, a stereo camera 63 configured to obtain a stereoscopic image, an encoder 64 configured to obtain posture information indicating a current posture of the mirror 22 (for example, angles thereof in the pitch direction and the roll direction), a voice input apparatus 65 such as a microphone, an inertia measurement apparatus 66 configured to measure inertia, an RGB camera 67 configured to obtain a color image, and an infrared (IR) camera 68 configured to obtain an infrared image.

The human recognition process unit 42 is configured to recognize a user using the projection system 11. For example, the human recognition process unit 42 includes a position detection unit 71 configured to detect a position of the user, a posture detection unit 72 configured to detect a posture of the user, a face direction detection unit 73 configured to detect a face direction of the user, a field-of-view/line-of-sight detection unit 74 configured to detect a field of view and a line of sight of the user, and a hand finger detection unit 75 configured to detect hand fingers of the user.

The environment recognition process unit 43 is configured to recognize an environment in which the projection system 11 is to be used. For example, the environment recognition process unit 43 includes a brightness detection unit 81 configured to detect brightness in the environment, a plane detection unit 82 configured to detect how plane the projection surface is when viewed from the mirror reflection-type projector 13, a projection surface material texture/color detection unit 83 configured to detect a material texture and a color of the projection surface, and a blocking object detection unit 84 configured to detect whether or not there is a blocking object.

The pointing recognition process unit 44 is configured to perform a process for recognizing a pointing device used by the user using the projection system 11. For example, the pointing recognition process unit 44 includes a bright point detection unit 91 configured to detect a bright point of laser light outputted from the pointing device.

The output content color tone deciding unit 45 is configured such that, for example according to the material texture and color of the projection surface detected by the projection surface material texture/color detection unit 83, the output content color tone deciding unit 45 decides a color tone of the content to be outputted from the mirror reflection-type projector 13 in order that the image projected on the projection surface may have the original colors of the content.

The output position deciding unit 46 is configured to decide an output position to which the mirror reflection-type projector 13 will output the content.

The output time/timing deciding unit 47 is configured to decide an output time during which the mirror reflection-type projector 13 will output the content, and a timing at which the mirror reflection-type projector 13 will output the content.

The output content compensation process unit 48 is configured to carry out a compensation process to the content to be outputted from the mirror reflection-type projector 13, the output content compensation process unit 48 carrying out the compensation process according to the current posture information of the mirror 22 obtained by the encoder 64, the color tone decided by the output content color tone deciding unit 45, the output position decided by the output position deciding unit 46, the output time and the timing decided by the output time/timing deciding unit 47. For example, the output content compensation process unit 48 is configured to carry out a compensation process for rotating or reversing the content so as to orient the content upside up according to the projection orientation. Moreover, the output content compensation process unit 48 is configured to carry out a compensation process for generating a combined image by appropriately combining the image assigned to the direct light and the image assigned to the reflection light into the original image according to the current posture information of the mirror 22, as described above referring to FIG. 8.

Here, the posture information of the mirror 22 corresponds to the projection position of the image. Therefore, the output content compensation process unit 48 can determine, on the basis of the posture information of the mirror 22 and according to where is the projection position to which the image will be projected, whether or not the projection light (or at least part of the projection light) to be outputted from the mirror reflection-type projector 13 will be reflected by the mirror 22. Similarly, the output content compensation process unit 48 can determine, on the basis of the posture information of the mirror 22, whether or not the image to be projected from the mirror reflection-type projector 13 will be projected across the mirror unuse boundary (that is, part of the image will be reflected by the mirror 22 and remaining part will not be reflected by the mirror 22).

The output control unit 49 is configured to control the output from the mirror reflection-type projector 13 in such a way that the content subjected to the compensation process by the output content compensation process unit 48 will be appropriately projected. For example, the output control unit 49 is configured to perform such control that changes the posture of the mirror 22 according to the projection position of the image, that is, changes the angles of the mirror 22 in the pitch direction and the roll direction according to the projection position of the image. Furthermore, the output control unit 49 is configured such that, in a case where the compensation process for appropriately combining the image assigned to the direction light and the image assigned to the reflection light into the original image, the output control unit 49 controls a target posture of the mirror 22 according to the current posture information of the mirror 22 in such a way that the image assigned to the direct light will not be reflected by the mirror 22 and the image assigned to the reflection will be reflected by the mirror 22.

The output unit 50 is configured to output to the mirror reflection-type projector 13. For example, the output unit 50 includes a mirror-driving motor 101 configured to control a pitch motor 24 and the roll motor 26 configured to move the mirror 22, a projector output apparatus 102 configured to supply an image to the mirror reflection-type projector 13, and a projector zoom/focus adjusting apparatus 103 configured to adjust zoom and focus of the mirror reflection-type projector 13.

Note that the input unit 41 and the output unit 50 are constituted by various hardware as described above, while, for example, the functions of the human recognition process unit 42, the environment recognition process unit 43, and the pointing recognition process unit 44 are realized by firmware. Moreover, the functions of the output content color tone deciding unit 45, the output position deciding unit 46, the output time/timing deciding unit 47, the output content compensation process unit 48, and the output control unit 49 are realized by applications. That is, the projection system 11 includes one or more circuits such as central processing units (CPUs) or digital signal processors (DSPs) for executing the firmware and applications.

### Content Output Control Process

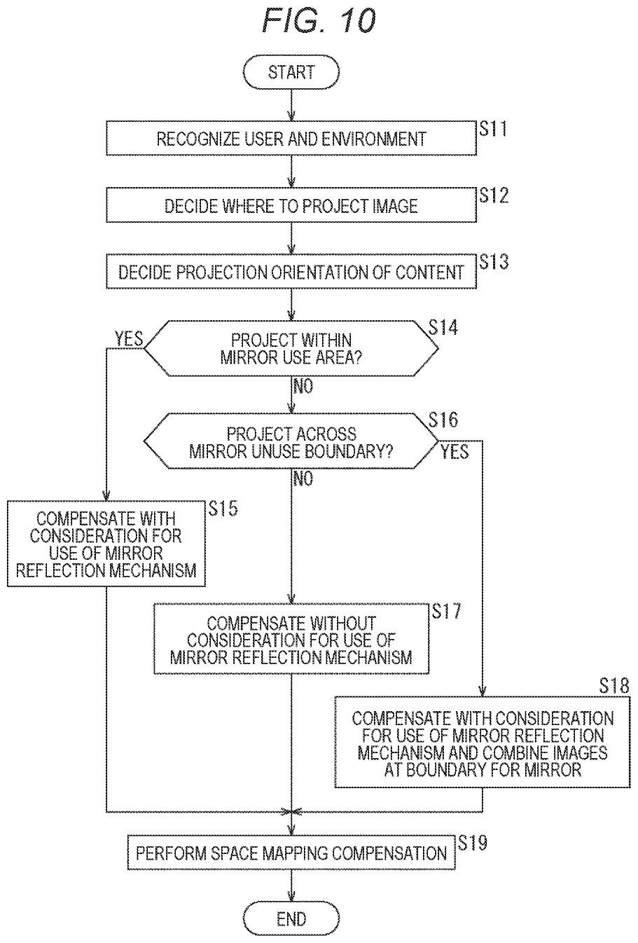

Referring to a flowchart illustrated in FIG. 10, a content output control process carried out in the projection system 11 will be described herein.

For example, the process is carried out per frame of the image to be projected from the mirror reflection-type projector 13, and at step S11, the human recognition process unit 42 and the environment recognition process unit 43 carry out the processes for recognizing the user using the projection system 11 and the environment for the use of the projection system 11. As a result of this, the projection system 11 obtains environment information necessary for recognizing three-dimensional shapes in order that the image may be projected, without distortion, in the space for the use of the projection system 11, user information necessary for determining the orientation of the content in order to project the image on the floor surface or the ceiling surface, and/or the like information.

For example, the human recognition process unit 42 carries out the process for recognizing the user using the projection system 11 in order to detect the position, posture, face direction, field of view, line of sight, hand fingers, and/or the like of the user, and outputs the user information indicative of a result of the detection. Moreover, the environment recognition process unit 43 carries out the process for recognizing the environment for the use of the projection system 11 in order to detect the brightness of the environment, how plane the projection surface is, the material texture and color of the projection surface, whether or not there is a blocking object, and/or the like, and outputs the environment information indicative of a result of the detection.

At step S12, the output position deciding unit 46 decides, on the basis of the environment information obtained at step S11, the output position of the content in an indoor space in which the projection system 11 is to be used, that is, the projection position to which the image is to be projected.

At step S13, according to the output position determined by the output position deciding unit 51 at step S12, the output content compensation process unit 48 decides, on the basis of the user information and the environment information obtained at step S11, the projection orientation for the output of the content if the content has a direction with an upside and a downside as described above referring to FIG. 6.

At step S14, according to the output position of the content decided by the output position deciding unit 51 at step S12, the output content compensation process unit 48 determines whether or not to project the image within a mirror use area to which the content is to be projection by the reflection light by using the mirror 22 (that is, out of the mirror unuse area explained above referring to FIG. 7).

If the output position deciding unit 51 determines to project the image in the mirror use area at step S14, the process goes to step S15. That is, in this case, the mirror reflection-type projector 13 will use the mirror reflection mechanism 28 in order to output the content.

At step S15, as explained above referring to FIG. 7, the output content compensation process unit 48 carries out the compensation process for reversing or rotating the image in such a way that the content will be upside up according to the projection orientation of the content with consideration for the use of the mirror reflection mechanism 28.

On the other hand, if the output content compensation process unit 48 determines not to project the image within the mirror use area at step S14, the process goes to step S16. At step S16, the output content compensation process unit 48 determines whether or not to project the image across the mirror unuse boundary.

If the output content compensation process unit 48 determines not to project the image across the mirror unuse boundary in step S16, the process goes to step S17. That is, in this case, the mirror reflection-type projector 13 will project the image within the mirror unuse area without using the mirror reflection mechanism 28 in order to output the content.

At step S17, the output content compensation process unit 48 carries out the compensation process to the image on the basis of the original angle of view of the mirror reflection-type projector 13 without consideration for the use of the mirror reflection mechanism 28, as described above referring to FIG. 7.

On the other hand, if the output content compensation process unit 48 determines to project the image across the mirror unuse boundary, the process goes to step S18.

At step S18, the output content compensation process unit 48 carries out the compensation process for reversing or rotating the image with consideration for the use of the mirror reflection mechanism 28 as described above referring to FIG. 8, and carries out the image process for combining the image assigned to the direct light and the image assigned to the reflection light across the boundary regarding the mirror 22.

After the process at step S15, step S17, or step S18, the process goes to step S19. At step S19, the output content compensation process unit 48 carries out space mapping compensation for compensating the image in such a way that the image will be projected in the space without distortion, according to how plane the projection surface when viewed from the mirror reflection-type projector 13.

After that, the image subjected to the space mapping compensation at step S19 is outputted to the mirror reflection-type projector 13 from the projector output apparatus 102 according to control by the output control unit 49, and the image is projected to the projection position decided at step S12. Thereafter, the process is ended. After that, a similar process is repeated to a next frame of the image.

As described above, by carrying out the content output control process in the projection system 11, it is possible to project the image with the projection orientation suitable for the posture of the user or the like, and it is possible to project the image appropriately with consideration for the use of the mirror reflection mechanism 28 in a wider range.

### Image Process in Content Output Control Process

Referring to FIGS. 11 to 17, an image process carried out in the content output control process will be described herein.

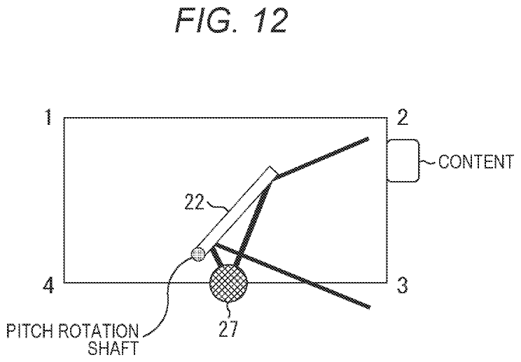

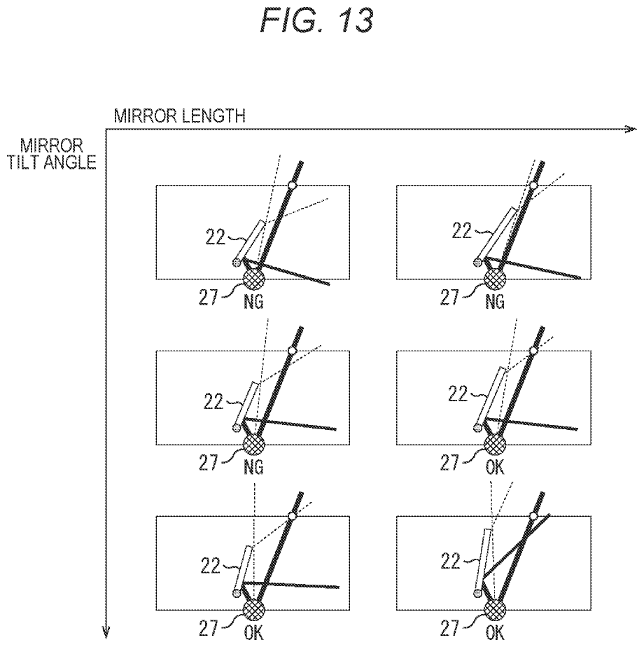

To begin with, as illustrated in FIG. 11, a cross-sectional direction of the space with respect to the mirror reflection-type projector 13 is defined, and the pitch rotation of the mirror 22 is schematized as illustrated in FIG. 12. In this case, as illustrated in FIG. 13, if a length of the mirror 22 is shorter, the two images, namely, the image assigned to the direct light without the reflection on the mirror 22 and the image assigned to the reflection light with the reflection on the mirror 22 (see FIG. 8) will not be combined unless the pitch of the mirror 22 is further rotated.

That is, in FIG. 13, combinations of the mirror length and mirror tilt angle with which the two image can be combined are indicated as “OK”, whereas combinations of the mirror length and mirror tilt angle with which the two image cannot be combined are indicated as “NG”.

Therefore, the projection system 11 is so configured to perform such an image process that the length of the mirror 22, the pitch rotation angle of the mirror 22, a relative distance between the pitch rotation axes and the light source 27, the angle of view of the projector main unit 21, and/or the like are adjusted to combine the two image in the space.

It should be noted that the projection system 11 may be configured to perform such an image process that, in order to make a boundary between the two image less visible, overlaps the two image partially and a color tone, gamma curve, and/or the like is adjusted to thereby make the boundary less visible. Moreover, it may be so configured that, if the two image cannot be combined, an image process for blurring a vicinity of the boundary between the two image so as to make a gap between the two image less visible.

Here, in a case where the content has a direction with an upside and a downside, it is necessary that the projection orientation of the content be considered according to the posture or the like of the user viewing the content, and in a case where the content does not have a direction with an upside and a downside, it is not necessary that the projection orientation of the content be considered. Accordingly, the content output control process carries out different image processes for the case where the content has a direction with an upside and a downside and the case where the content does not have a direction with an upside and a downside.

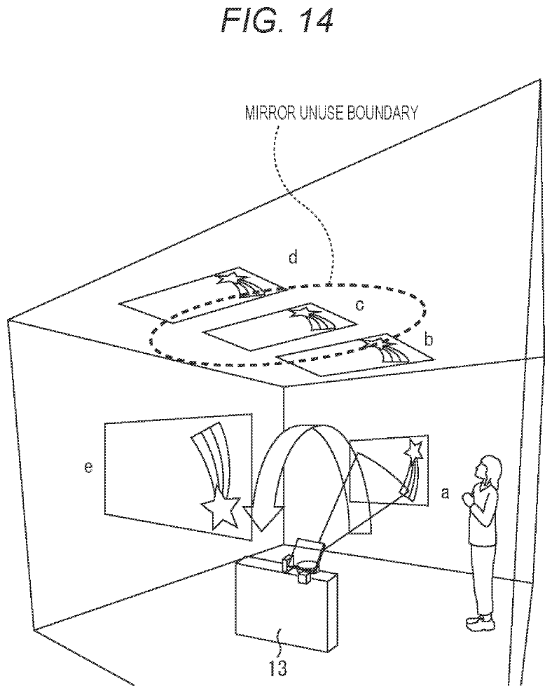

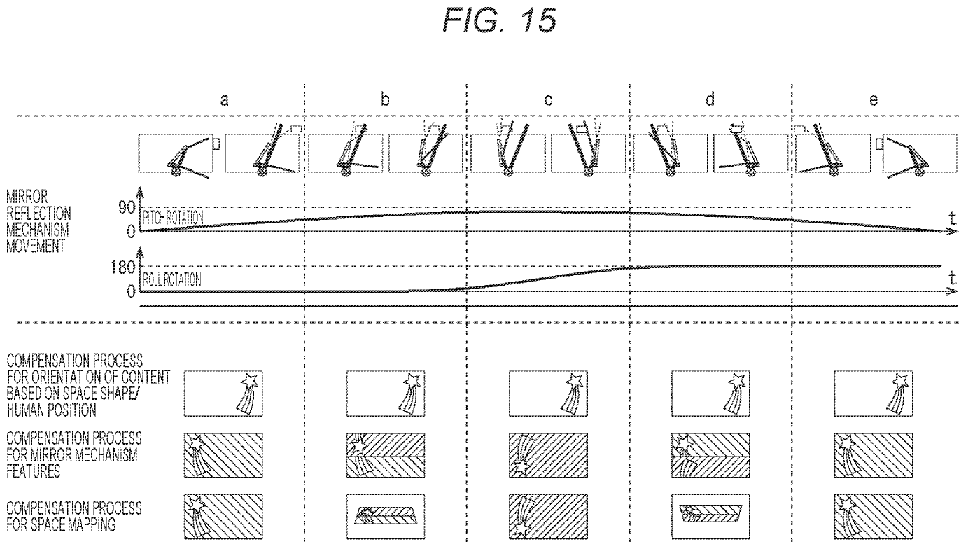

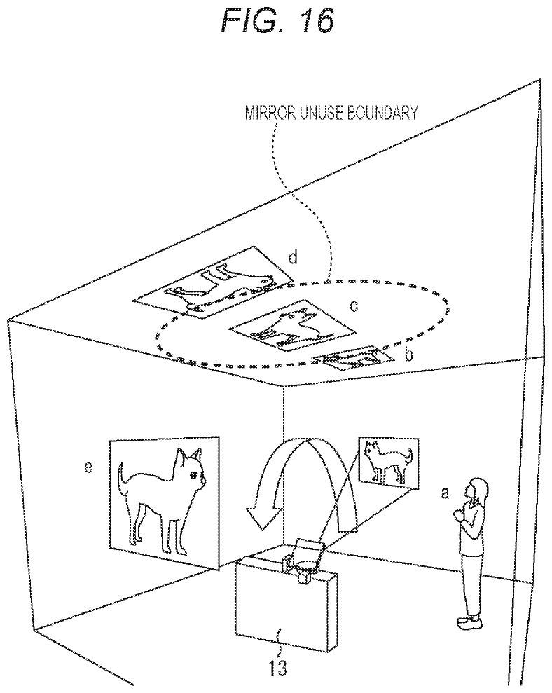

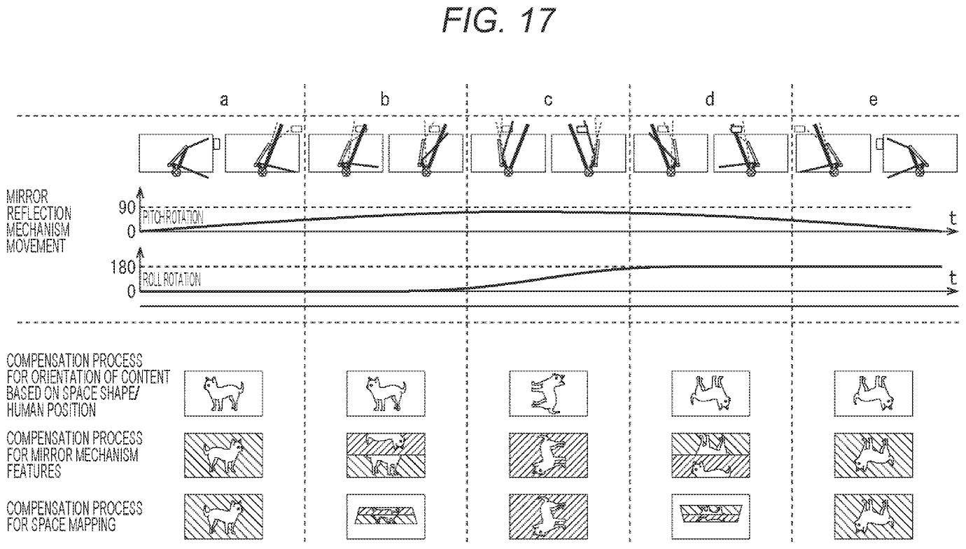

To being with, referring to FIGS. 14 and 15, the image process for the case where the content does not have a direction with an upside and a downside will be described, and then referring to FIGS. 16 and 17, the image process for where the content has a direction with an upside and a downside will be described.

FIG. 14 illustrates an example where an image of a shooting star is projected as a content without a direction with an upside and a downside.

As an example, an example in which the content is outputted continuously from output positions a to e as illustrated in FIG. 14 will be described. For example, the output position a is out of the mirror unuse area, the output position b is across the mirror unuse boundary, and the output position c is in the mirror unuse area. Moreover, the output position d is across the mirror unuse boundary, and the output position c is in the mirror unuse area.

Thus, as illustrated in FIG. 14, in a case where the user stands on the right-hand side of the mirror reflection-type projector 13, the content is moved from the output position a on the side surface on the right-hand side of the user, through the output position c on the ceiling surface, and to the output position d on the side surface on the left-hand side of the user. Here, the image of the shooting star can be projected with any content orientations without the need of considering the position of the user.

Furthermore, FIG. 15 illustrates movement of the mirror reflection mechanism 28 for the content output from the output positions a to e as illustrated in FIG. 14, and exemplary contents of the process of steps S13, S14 to S18 and step S19 as illustrated in FIG. 10.

As illustrated in FIG. 15, the mirror reflection mechanism 28 performs the pitch rotation continuously from the output positions a to e, and in doing so, the mirror reflection mechanism 28 performs the roll rotation only for the output position c. Moreover, for the output position a and the output position e, the compensation process for reversing the right and left is carried out because the image with the reflection of the mirror 22 only is projected (step S15 in FIG. 10). On the other hand, for output position c, the image without the reflection of the mirror 22 is projected, and therefore the compensation process for reversing to exchange the right with the left is not carried out (step S17 in FIG. 10).

Moreover, for the output positions b and d, the image is projected across the mirror unuse boundary, and therefore, the image process for combining an image subjected to the compensation for reversing to exchange the right with the left and an image not subjected to the compensation into one example is carried out (step S18 in FIG. 10). Furthermore, for the output position b, the two image are combined, gradually increasing a ratio of the image assigned to the direct light without the reflection of the mirror 22 over the image assigned to the reflection light with the reflection of the mirror 22. Then, for the output position d, on the contrary, the two image are combined, gradually increasing a ratio of the image assigned to the direct light with the reflection of the mirror 22 over the image assigned to the reflection light without the reflection of the mirror 22. Furthermore, in association with this, the mirror 22 is moved in advance by roll rotation in order that the mirror 22 not used at the moment can be used for the next projection surface.

FIG. 16 illustrates an example in which an image of a puppy is projected as a content having a direction with an upside and a downside.

FIG. 16 illustrates a case the content whose orientation is rotated according to the position of the user is viewed, unlike the case explained in FIG. 14. As illustrated in FIG. 16, for example, for a creature or an object whose has a direction according to the physical rules, orientation thereof should be changed according to the position of a person as illustrated in FIG. 16 in order to be viewed without feeling strangeness.

Therefore, as illustrated in FIG. 17, the compensation of the orientation of the content according to the space shape/human position, that is, the process for deciding the projection orientation of the content (step S13 in FIG. 10) is carried out, thereby performing the image process for rotating the image. An angle in the image process is calculated out by reverse calculation to reverse the rotation of the image as illustrated in FIG. 7.

Note that the compensation process for the mirror mechanism (step S15, step S17, or step S18 in FIG. 10) and the space mapping compensation (step S19 in FIG. 10) are carried out for the content having a direction with an upside and a downside as well as for the content having not direction with an upside and a downside.

### Exemplary Configuration of Driven-Type Projector

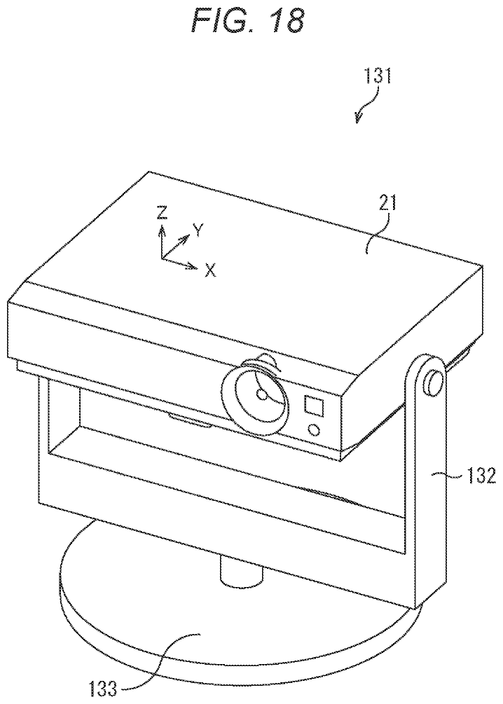

Referring to FIGS. 18 to 20, a driven-type projector 131 in which a projector main unit 21 is moved will be described herein.

The compensation process for deciding, on the basis of the user information and the environment information, the projection orientation for the output of the content (step S13 in FIG. 10) and the compensation process for performing the space mapping compensation for compensating the image in such a way that the image can be project in the space without distortion (step S13 in FIG. 10) can be applied the driven-type projector 131.

FIG. 18 illustrates a configuration of an outer appearance of the driven-type projector 131.

As illustrated in FIG. 18, the driven-type projector 131 is configured by mounting a projector main unit 21 mounted on the tilting mechanism 132 and a panning mechanism 133. With such a configuration, the tilting mechanism 132 drives the projector main unit 21 in a tilt direction and the panning mechanism 133 drives the projector main unit 21 in a panning direction.

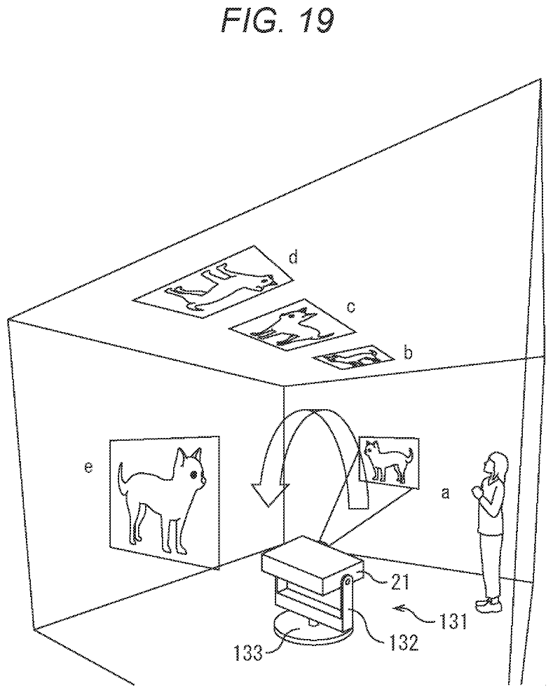

As illustrated in FIG. 19, the driven-type projector 131 with such a configuration is also capable of projecting the image while moving the image from the output positions a to e on a track similar to that of the mirror reflection-type projector 13 described above.

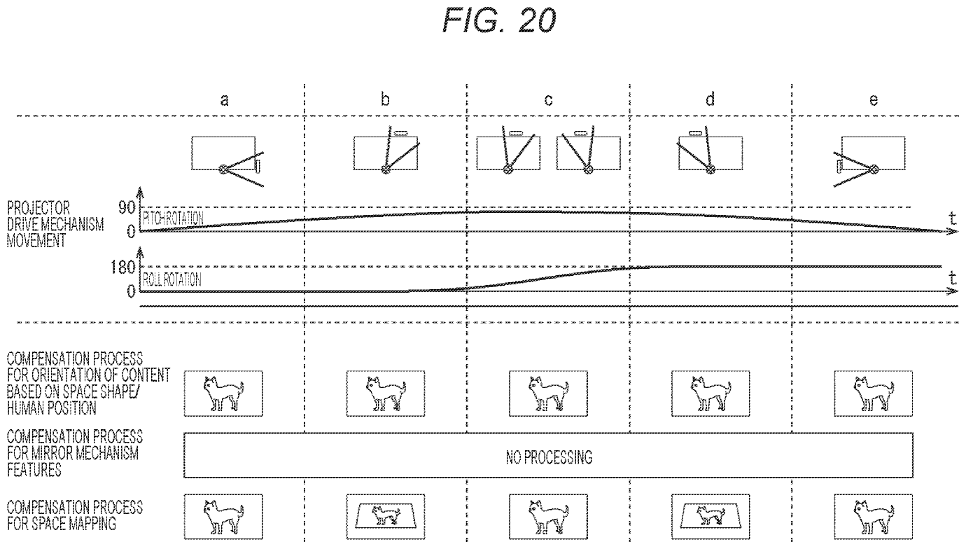

FIG. 20 illustrates an example of an image process for the image projection carried out by the driven-type projector 131.

The driven-type projector 131 is so configured that the process for rotating the image with consideration for the use of the mirror reflection mechanism 28 (step S15 in FIG. 10) is not carried out because the projector main unit 21 is driven and moved in the driven-type projector 131, for example. That is, the driven-type projector 131 is so configured that, instead of the process for rotating the image, the roll rotation of the projector main unit 21 is carried out in the space mapping compensation.

For example, the driven-type projector 131 is so configured that the angle of view of the projector main unit 21 is utilized to move the content within the image without 90° rotation in the pitch direction in order to perform such expression that the content is moved upward by 90°. With this configuration, the driven-type projector 131 can avoid the need of hurriedly moving the tilting mechanism 132 and the panning mechanism 133.

In the projection system 11 as configured above, the mirror reflection-type projector 13 is capable of projecting an image in a very wide range without such a case that the mirror reflection mechanism 28 itself blocks the light projected from the projector main unit 21. Moreover, as illustrated in FIG. 4, the mirror reflection-type projector 13 can be used with the mirror 22 in the stored state in which the mirror 22 is completely folded down.

Moreover, by combining the image projected by the reflection with the mirror 22 and the image projected without the reflection by the mirror 22, the projection system 11 is capable of moving the image continuously in all directions except occlusion caused by the projection system 11 itself. Furthermore, the present technology is also applicable to the driven-type projector 131, as explain referring to FIGS. 18 to 20.

Note that, in the present embodiment, the posture information of the mirror 22 includes both a value of a systematic target posture (posture targeted by the movement of the mirror 22) and a value of the current physical posture (current rotation angles of the pitch motor 24 and the roll motor 26 obtained by the encoder 64). Furthermore, the image encompasses a still image and a moving image.

### Exemplary Configuration of Computer

Next, the series of processes (control process method) described above may be carried out with hardware or software. In case where the series of processes is carried out with software, a program constituting the software is installed on a general-purpose computer or the like.

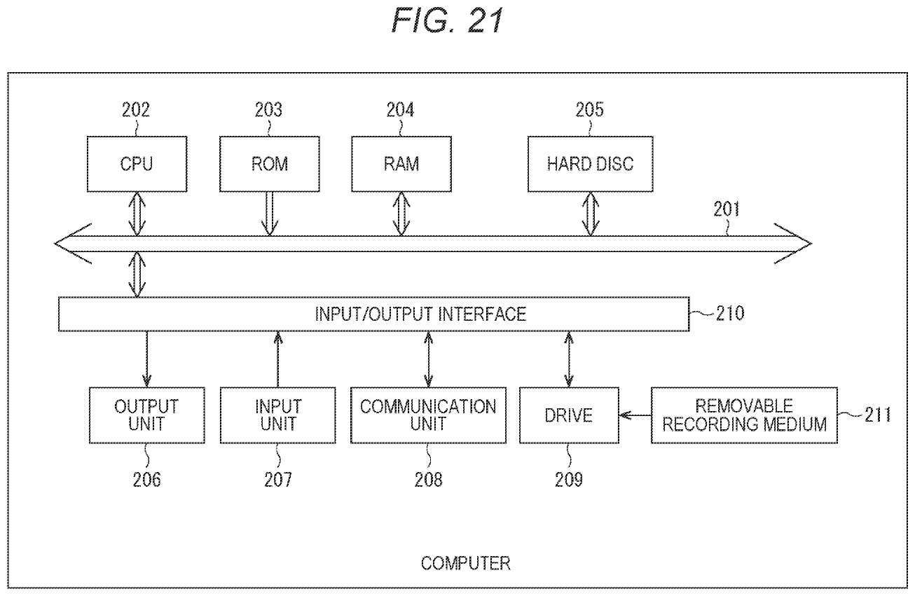

FIG. 21 is a block diagram illustrating one exemplary configuration of one embodiment of a computer on which the program for executing the series of processes is installed.

The program may be stored, in advance, on a hard disc 205 or a read-only memory (ROM) 203 as a recording medium provided in the computer.

As an alternative, the program may be stored (recorded) in a removable recording medium 211 that is drivable by a drive 209. Such a removable recording medium 211 may be provided as so-called package software. Here, examples of the removable recording medium 211 includes a flexible disc, a compact disc read only memory (CD-ROM), a magneto-optical disc (MO), digital versatile disc (DVD), a magnetic disc, a semiconductor memory, and the like.

It should be noted that the program may be installed on the computer from the removable recording medium 211 as described above or may be downloaded via a communication network or a broadcast network to the computer and installed on the hard disc 205 provided in the computer. That is, for example, the program may be wirelessly from a download site to the computer via an artificial satellite for digital satellite broadcast or may be forwarded to the computer via a network such as a local area network (LAN) or internet by wired communication.

The computer includes a central processing unit (CPU) 202 to which an input/output interface 210 is connected via a bus 201.

The CPU 202 is configured to execute the program stored in a read-only memory (ROM) 203 according to instructions inputted, via the input/output interface 210, by operation of an input unit 207 by a user or the like. As an alternative, the CPU 202 is configured to load the program from the hard disc 205 to a random-access memory (RAM) 204.

With this configuration, the CPU 202 performs the process according to the flowchart described above or the process carried out with the configuration illustrated in the block diagram described above. After that, if necessary, the CPU 202 carries out, for example, output of a result of the process from an output unit 206 via the input/output interface 210, transmission of the result of the process from a communication unit 208, storing of the result of the process into the hard disc 205, or the like operation.

Note that the input unit 207 is constituted by a keyboard, a mouse, a microphone, or the like. Moreover, the output unit 206 is constituted by a liquid crystal display (LCD), a speaker, or the like.

Here, in this specification, the processing steps executed by a computer in accordance with a program do not always have to be executed in a time-sequential manner in the order described as the flowchart. That is, processing executed by the computer in accordance with the program includes processing in a parallel or discrete manner (for example, parallel processing or object-based processing).

Furthermore, with regard to the program, processing may be carried out by one computer (one processor), or processing may be carried out in a distributed manner by a plurality of computers. In addition, the program may be transferred to a remote computer and executed.

Further, in this specification, a system has the meaning of a set of a plurality of structural elements (such as an apparatus or a module (part)), and does not take into account whether or not all the structural elements are in the same casing. Therefore, the system may be either a plurality of apparatuses stored in separate casings and connected through a network, or an apparatus in which a plurality of modules is stored within a single casing.

Further, for example, an element described as a single device (or processing unit) may be divided and configured as a plurality of devices (or processing units). Conversely, elements described as a plurality of devices (or processing units) above may be configured collectively as a single device (or processing unit). Further, an element other than those described above may be added to the configuration of each device (or processing unit). Furthermore, a part of the configuration of a given device (or processing unit) may be included in the configuration of another device (or another processing unit) as long as the configuration or operation of the system as a whole is substantially the same.

In addition, for example, the present technology can adopt a configuration of cloud computing which performs processing by allocating and sharing one function by a plurality of devices through a network.

In addition, for example, the program described above can be executed in any device. In that case, it is sufficient if the device has a necessary function (functional block etc.) and can obtain necessary information.

In addition, for example, each step described by the above-described flowcharts can be executed by one device or executed by being allocated to a plurality of devices. Furthermore, in the case where a plurality of processes is included in one step, the plurality of processes included in this one step can be executed by one device or executed by being allocated to a plurality of devices. In other words, a plurality of processes included in one step can be executed as processing of a plurality of steps. Conversely, processing described as a plurality of steps can be executed collectively as one step.

Note that in a program executed by a computer, processing in steps describing the program may be executed chronologically along the order described in this specification, or may be executed concurrently, or individually at necessary timing such as when a call is made. In other words, unless a contradiction arises, processing in the steps may be executed in an order different from the order described above. Furthermore, processing in steps describing the program may be executed concurrently with processing of another program, or may be executed in combination with processing of another program.

Note that the plurality of present technologies described in this specification can be performed alone independently of each other, unless a contradiction arises. Of course, any plurality of the present technologies can be performed in combination. For example, part or the whole of the present technology described in any of the embodiments can be performed in combination with part or whole of the present technology described in another embodiment. In addition, part or the whole of any of the present technologies described above can be performed in combination with another technology that is not described above.

### Example of Combination of Configurations

Additionally, the present technology may also be configured as below.

(1)

A control apparatus including:

a compensation process unit configured to perform a compensation process to an image content projected by a projection unit, the compensation process unit performing the compensation process on the basis of posture information indicative of a posture of a mirror configured to be capable of reflecting at least part of projection light outputted from the projection unit; and

a control unit configured to control output of the image content from the projection unit, the image content having been subjected to the compensation process by the compensation process unit.

(2)

The control apparatus according to (1),

in which the compensation process unit performs the compensation process to at least part of the image content in a case where the posture information indicates that the at least part of the projection light for projecting the image content is to be reflected by the mirror.

(3)

The control apparatus according to (2),

in which, in a case where the posture information indicates that part of the projection light for projecting the image content is to be projected as reflection light reflected from the mirror and remaining part of the projection light is projected as direct light without the reflection by the mirror, the compensation process unit performs the compensation process to an image of the part of the image content that is assigned to the reflection light but not to an image of the remaining part of the image content that is assigned to the direct light.

(4)

The control apparatus according to (3),

in which the compensation process unit generates a combined image by combining the part of the image content that is assigned to the reflection light and the image of the remaining part of the image content that is assigned to the direct light, and

the control unit causes the projection unit to output the combined image.

(5)

The control apparatus according to (4),

in which the compensation process unit does not perform the compensation process to the image content, in a case where the posture information indicates that the projection light for projecting the image content is projected as the direct light without the reflection by the mirror.

(6)

The control apparatus according to any one of (1) to (5),

in which the compensation process is an image process for rotating or reversing the image content.

(7)

The control apparatus according to any one of (1) to (6),

in which the posture information is information regarding a projection position of the image content.

(8)

The control apparatus according to (7),

in which the posture information includes information indicative of an angle of the mirror in a pitch direction with respect to a light axis of the projection unit.

(9)

The control apparatus according to (7),

in which the posture information includes information indicative of an angle of the mirror in a roll direction with respect to a light axis of the projection unit.

(10)

The control apparatus according to any one of (1) to (9),

in which the control unit performs control to change a posture of the mirror according to a projection position of the image content.

(11)

The control apparatus according to (10),

in which the control unit performs control to change the posture of the mirror in a pitch direction with respect to a light axis of the projection unit.

(12)

The control apparatus according to (10),

in which the control unit performs control to change the posture of the mirror in a roll direction with respect to a light axis of the projection unit.

(13)

The control apparatus according to any one of (1) to (11), further including:

an environment recognition unit configured to recognize, as usage environment for the projection unit, a user who is to view the image content and a projection surface to which the image content is to be projected.

(14)

A control method, in which a control process apparatus configured to control projection of an image content includes:

performing a compensation process to the image content on the basis of posture information indicative of a posture of a mirror configured to be capable of reflecting at least part of projection light outputted from a projection unit configured to project the image content; and

controlling output of the image content from the projection unit, the image content having been subjected to the compensation process.

(15)

A program for causing a computer of a control process apparatus to perform a process, the control process apparatus being configured to control projection of an image content, the process including:

performing a compensation process to the image content on the basis of posture information indicative of a posture of a mirror configured to be capable of reflecting at least part of projection light outputted from a projection unit configured to project the image content; and

controlling output of the image content from the projection unit, the image content having been subjected to the compensation process.

Note that the present embodiment is not limited to the above-described embodiment, and can be changed in various manners within a scope not deviating from the gist of the present disclosure. Further, the effects described in this specification are merely illustrative or exemplified effects, and are not limitative, and the technology according to the present disclosure may achieve other effects.

### REFERENCE SIGNS LIST

11 Projection system
12 Sensor module
13 Mirror reflection-type projector
14 Control process apparatus
21 Projector main unit
22 Mirror
23 Pitch arm
24 Pitch motor
25 Roll arm
26 Roll motor 2
27 Light source
28 Mirror reflection mechanism
41 Input unit
42 Human recognition process unit
43 Environment recognition process unit
44 Pointing recognition process unit
45 Output content color tone deciding unit
46 Output position deciding unit
47 Output time/timing deciding unit
48 Output content compensation process unit
49 Output control unit
50 Output unit
61 Thermo camera
62 TOF camera
63 Stereo camera
64 Encoder
65 Voice input apparatus
66 Inertia measurement apparatus
67 RGB camera
68 IR camera
71 Position detection unit
72 Posture detection unit
73 Detection unit
74 Field-of-view/line-of-sight detection unit
75 Hand finger detection unit
81 Brightness detection unit
82 Plane detection unit
83 Projection surface material texture/color detection unit
84 Blocking object detection unit
91 Bright point detection unit
101 Mirror-driving motor
102 Projector output apparatus
103 Projector zoom/focus adjusting apparatus

1. A control apparatus comprising:
a compensation process unit configured to perform a compensation process to an image content projected by a projection unit, the compensation process unit performing the compensation process on a basis of posture information indicative of a posture of a mirror configured to be capable of reflecting at least part of projection light outputted from the projection unit; and
a control unit configured to control output of the image content from the projection unit, the image content having been subjected to the compensation process by the compensation process unit.

2. The control apparatus according to claim 1,
wherein the compensation process unit performs the compensation process to at least part of the image content in a case where the posture information indicates that the at least part of the projection light for projecting the image content is to be reflected by the mirror.

3. The control apparatus according to claim 2,
wherein, in a case where the posture information indicates that part of the projection light for projecting the image content is to be projected as reflection light reflected from the mirror and remaining part of the projection light is projected as direct light without the reflection by the mirror, the compensation process unit performs the compensation process to an image of the part of the image content that is assigned to the reflection light but not to an image of the remaining part of the image content that is assigned to the direct light.

4. The control apparatus according to claim 3,
wherein the compensation process unit generates a combined image by combining the part of the image content that is assigned to the reflection light and the image of the remaining part of the image content that is assigned to the direct light, and
the control unit causes the projection unit to output the combined image.

5. The control apparatus according to claim 4,
wherein the compensation process unit does not perform the compensation process to the image content, in a case where the posture information indicates that the projection light for projecting the image content is projected as the direct light without the reflection by the mirror.

6. The control apparatus according to claim 4,
wherein the compensation process is an image process for rotating or reversing the image content.

7. The control apparatus according to claim 1,
wherein the posture information is information regarding a projection position of the image content.

8. The control apparatus according to claim 7,
wherein the posture information includes information indicative of an angle of the mirror in a pitch direction with respect to a light axis of the projection unit.

9. The control apparatus according to claim 7,
wherein the posture information includes information indicative of an angle of the mirror in a roll direction with respect to a light axis of the projection unit.

10. The control apparatus according to claim 1,
wherein the control unit performs control to change a posture of the mirror according to a projection position of the image content.

11. The control apparatus according to claim 10,
wherein the control unit performs control to change the posture of the mirror in a pitch direction with respect to a light axis of the projection unit.

12. The control apparatus according to claim 10,
wherein the control unit performs control to change the posture of the mirror in a roll direction with respect to a light axis of the projection unit.

13. The control apparatus according to claim 1, further comprising:
an environment recognition unit configured to recognize, as usage environment for the projection unit, a user who is to view the image content and a projection surface to which the image content is to be projected.

14. A control method, wherein a control process apparatus configured to control projection of an image content comprises:
performing a compensation process to the image content on a basis of posture information indicative of a posture of a mirror configured to be capable of reflecting at least part of projection light outputted from a projection unit configured to project the image content; and
controlling output of the image content from the projection unit, the image content having been subjected to the compensation process.

15. A program for causing a computer of a control process apparatus to perform a process, the control process apparatus being configured to control projection of an image content, the process comprising:
performing a compensation process to the image content on a basis of posture information indicative of a posture of a mirror configured to be capable of reflecting at least part of projection light outputted from a projection unit configured to project the image content; and
controlling output of the image content from the projection unit, the image content having been subjected to the compensation process.
